(19) United States
(12) Patent Application Publication
(10) Pub. No.: US 2026/0097805 A1
(43) Pub. Date: Apr. 9, 2026

(54) LINEAR GEAR ARRANGEMENT AND MOTOR VEHICLE HAVING A LINEAR GEAR ARRANGEMENT

(71) Applicant: Schaeffler Technologies AG & Co. KG, Herzogenaurach (DE)

(72) Inventors: Maximilian BOSSECKER, Hügelsheim (DE); Stefan LENSSEN, Bühl (DE); Martin VORNEHM, Bühl (DE)

(73) Assignee: Schaeffler Technologies AG & Co. KG, Herzogenaurach (DE)

(21) Appl. No.: 19/328,613

(22) Filed: Sep. 15, 2025

(30) Foreign Application Priority Data
Oct. 9, 2024 (DE) 102024129056.0

(51) Int. Cl. B62D 5/04; B62D 15/02; F16H 25/20

(52) U.S. Cl. CPC B62D 5/0424; B62D 5/0448; B62D 15/024; F16H 25/20; F16H 2025/2096

(57) ABSTRACT

A linear gear arrangement having a threaded spindle and a spindle nut arranged coaxially thereto, which can be moved along the threaded spindle. The linear gear arrangement has a first motor with a first belt running around a first drive wheel, and a second motor having a second belt running around a second drive wheel. The two belts also wrap around the spindle nut and bear axially adjacent to one another on the spindle nut. A separating element is arranged in a radially extending plane located axially between the belts, and extends radially at least far enough to shield the strand sections of the two belts from one another. The separating element extends coaxially around the spindle nut. An angle sensor is arranged on the separating element, and the angle sensor interacts with a target arranged on the spindle nut to detect the angular position of the spindle nut.

### CROSS-REFERENCE TO RELATED APPLICATIONS

This application claims priority from German Patent Application No. 10 2024 129 056.0, filed Oct. 9, 2024, which is incorporated herein by reference as if fully set forth.

### TECHNICAL FIELD

The present disclosure relates to a linear gear arrangement. Furthermore, the disclosure relates to a motor vehicle having said linear gear arrangement, in particular for use in a steering device, which is also referred to as a steer-by-wire system.

### BACKGROUND

Various steering devices for motor vehicles are known. For example, the steering devices may have a drive with one or two motors and/or one or two belts that apply a steering force to a steering linkage.

A steering device having two motors, two ball nuts on each ball screw part and each having a belt is known from EP 3 782 875 A1, for example.

Steer-by-wire systems (SbW for short) are used to replace a mechanical steering column. Steer-by-wire systems usually comprise a module for steering the front axle, the road wheel actuator (RWA for short), and a steering actuator, the hand wheel actuator (HWA for short). The steering angle is set by the steering actuator via the steering wheel, which can be steered by a driver. Based on this, the steering actuation takes place via the road wheel actuator. These components require fail-safe operation.

In known steer-by-wire systems, which have two redundant linear gears (e.g., dual pinion), the entire gear can either block or become stiff in the event of a fault. This has the effect that the redundant drive is also prevented from assuming its proper function, in which it should “step in” in the event of a malfunction. In alternative steer-by-wire systems, which, for example, only have one belt, the gear or the belt opens, so that this design also does not offer complete fail-safe protection.

In arrangements that use a motor with two three-phase windings on a stator, a rotor and a housing (dual winding), the winding systems can adversely affect one another in the event of a fault. Electronic defects such as those caused by heat or fire can also destroy electronics in the same housing, resulting in the failure of the entire system.

DE 10 2022 200 037 A1 describes a linear steering system for a motor vehicle comprising a first and a second drive unit. The first drive unit is connected to an output rod by a first ball screw drive, in particular a first electric motor is connected to a first steering control unit. The second drive unit is connected to the output rod by a second ball screw drive, in particular a second electric motor is connected to a second steering control unit. The first and second ball screws are designed to drive and support the output rod.

A steering device of a vehicle is known from US 2024/0227921 A9 which has a threaded spindle with two opposite ends connected to wheels. The spindle can be moved axially in a housing. Furthermore, the steering device comprises a ball nut which engages with the threaded spindle. A first nut belt pulley and a second nut belt pulley are coupled to the ball nut. The steering device further comprises a first motor for applying a torque to the ball nut via the first nut belt pulley and a second motor for applying a torque to the ball nut via the second nut belt pulley. The centrally located ball nut gear requires two bearing elements at the ends of the road wheel actuator.

A steering drive of a motor vehicle having an electric motor is known from DE 10 2022 212 649 A1. The motor is operatively connected to an actuator element via a belt drive. The belt drive comprises a drive wheel and a driven wheel around which a belt runs. Furthermore, the steering drive comprises a monitoring device for detecting the operating parameters of the belt drive. For drive purposes, a plurality of belts can be arranged in parallel, wherein at least one guide element is arranged between the belts.

In such belt drives, the drive wheel and driven wheel can be referred to together as belt wheels or belt pulleys.

### SUMMARY

Based on the prior art, an object of the present disclosure is to provide an improved, compact and fail-safe linear gear arrangement which can be used primarily in steering systems, in particular steer-by-wire systems. Furthermore, a motor vehicle having such a linear gear arrangement is to be provided.

This object is achieved by a linear gear arrangement having one or more of the features disclosed herein, and by a motor vehicle having such a linear gear arrangement having one or more of the features disclosed herein.

The linear gear arrangement according to the disclosure comprises a threaded spindle and a spindle nut arranged coaxially thereto, which together form the linear gear. As is well known, a threaded spindle is a machine element which, together with other elements, converts a rotary movement into a translational movement. The threaded spindle is also called the steering rod. The spindle nut can be moved axially along the threaded spindle, with relative rotation around the threaded spindle. Furthermore, the linear gear arrangement comprises a first motor having a first belt running around a first drive wheel and a second motor having a second belt running around a second drive wheel. As is well known, such belts have strand sections that run between a drive wheel and a driven wheel, or vice versa. The two belts continue to wrap around the spindle nut, which serves as the output gear. The two belts are arranged axially adjacent on the spindle nut. The linear gear assembly further comprises a separating element located axially between the two belts, which advantageously serves to protect one belt against a malfunction of the other belt, for example, if one tears or comes off. The separating element is arranged in a radially extending plane. The extension of the separating element corresponds radially to the extension of the strand sections of the belt, so that the strand sections are axially shielded from one another by the separating element. Furthermore, the separating element is arranged coaxially around the spindle nut, so that the spindle nut is radially completely or at least partially surrounded by the separating element. Furthermore, an angle sensor is attached to the separating element, in particular and advantageously for determining the angular position of the spindle nut, wherein the angle sensor interacts with a target arranged on the spindle nut.

The linear gear arrangement according to the disclosure has the advantage that the use of the separating element and the angle sensor arranged thereon with the target located on the spindle nut enables a measuring setup for the continuous monitoring of the gear arrangement which requires no additional installation space. A further advantage of the present linear gear arrangement is that it provides a high degree of fail-safe protection (fail-functional property), i.e., a solution for correcting malfunctions or for safely reacting to malfunctions. Due to the linear gear arrangement, functionality can be maintained in the event of a failure of a linear gear or a component of one of the two linear gears (e.g., one of the two motors or one of the two belts), since the angular position of the spindle nut and thus the absolute position can be clearly determined. Furthermore, the arrangement having two linear gears and a sensor arrangement allows the redundant linear gear to open the faulty linear gear in the event of a malfunction, allowing the other linear gear to continue working smoothly and unhindered. Suitable transmission or clutch elements are known and can be selected by the person skilled in the art. The present arrangement allows for precise control since a malfunction is always reliably detected. Thus, the present linear gear arrangement advantageously has a high degree of robustness against motor, control, and electronic defects. Due to the arrangement of the angle sensor on or at the separating element and the opposite target on the spindle nut, a high degree of measurement accuracy is advantageously ensured.

The measuring accuracy results from the design of the linear gear arrangement and the applicable measuring method, which is briefly explained below.

The diameters of the two drive wheels (also called belt pulleys) are preferably identical. Alternatively, the drive wheels can have different diameters. The diameters of the two drive wheels preferably result in transmission ratios of 2 to 4, particularly preferably 3. In one embodiment, the diameters are selected to result in different transmission ratios, so that angle detection using the Vernier principle (Vernier effect) enables a clear multi-turn angle measurement of the spindle nut. For different diameters of the drive wheels, the number of pinions that can be used for the Vernier principle is different. The absolute spindle nut position is determined using the Vernier algorithm. The Vernier principle is known to the person skilled in the art and is discussed, inter alia, in EP 3 733 483 A1, which shows a steering device having two motors and a signal detection device having two rotation angle sensors for determining an absolute position of a steered shaft.

The spindle nut used in the linear gear is preferably a ball screw nut. The spindle nut preferably consists of a metal. Alternatively, the spindle nut can be made of plastic. In an advantageous embodiment, a plastic element is arranged between the metallic spindle nut and the belt, wherein the plastic element has axially extending grooves on its radial outer side into which belt ribs can engage.

The linear gears can preferably be a ball screw spindle drive, a trapezoidal screw drive, or a planetary roller gearing.

The spindle nut preferably has a web on its lateral surface, i.e., on its outer circumferential surface. The web can also be called the central board or stop. The web extends radially outwards from the outer surface of the spindle nut and forms an elevation which is located axially between the two belts, in particular between the two bearing surfaces of the belts, on the spindle nut. The target is preferably arranged on the web. Preferably, a radially extending shoulder is formed on the web, on which the target is preferably directly axially arranged. Alternatively, the web can have a plurality of elevations or cams around it, which serve as targets.

The target preferably consists of a metal. Preferably, the target has an annular shape, in particular the target is a metal ring which is arranged coaxially to the spindle nut. In one embodiment, the target is a metal ring with wings. Alternatively, the target may be a ring with a plurality of circumferentially formed recesses, wherein the recesses are preferably arranged radially outward.

The separating element is preferably located radially indirectly to the web of the spindle nut. The separating element is preferably a separating disc, which can also be referred to as a separator. In one embodiment, the separating element projects radially beyond the strand sections of the belts. The separating element preferably has recesses in the region of the drive wheels, in particular at least partially circular recesses, through which a motor shaft and/or a drive wheel can protrude.

The separating element preferably consists of a metal, a metal-coated plastic or a plurality of layered materials. Particularly preferably, the separating element is a sensor circuit board which simultaneously functions as a protective element and as a carrier of the angle sensor element, wherein the angle sensor element can be formed integrally with the separating element. If the separating element is made of metal, the angle sensor can be arranged on the separating element in the form of a printed circuit board (PCB for short). Alternatively, the angle sensor is integrated into the separating element, e.g., in the form of a printed circuit board. Printed circuit boards or circuit boards are known to have conductor tracks, which can preferably be designed as antenna and receiver conductor tracks for HF (high-frequency) signals. Particularly preferably, the angle sensor, in particular the circuit board, has a crescent-shaped structure which is formed axially on the surface of the separating element.

Thus, the sensor arranged on the separating element preferably operates inductively, wherein the sensor interacts with the target arranged on the spindle nut. Due to the crescent-shaped structure of the angle sensor attached to the separating element and the wing-shaped target structure, for example, the angle sensor and the target overlap to varying degrees depending on the angle of rotation, resulting in a variable signal. The signal is generated by HF reflection from the metallic target, wherein the reflection intensity represents the angle.

Alternatively, the sensor arranged on the separating element operates according to the Hall principle, wherein a plurality of Hall sensors (Hall sensor chips) are arranged on the separating element, in particular in a crescent-shaped, axially located zone, and wherein the target consists of one or more permanent magnets. When the target overlaps with the sensor, a signal is generated. The permanent magnets can have the same or different orientations, so that additional coding of the angular position is possible.

In one embodiment, a plurality of sensors are attached to the separating element. The multiple sensors may have similar or different designs and/or functions. For example, a further sensor can be used to determine the angle of one or both drives. The further sensor then enables a multi-turn evaluation (Vernier principle) of the spindle nut rotation angle. The further sensor can also serve as protection and redundancy for the first sensor. Likewise, the additional sensor can be used to complete a limited angular range of the first sensor (e.g., only) 180° to a full 360° range.

A housing is preferably arranged around the motors. Furthermore, a sealing surface can be provided on the housing. The separating element is preferably detachably connected to the housing. Alternatively, the separating element may be non-removably connected to the housing. The two motors are preferably arranged in a single screwing plane, for example on the housing. Alternatively, the two motors are arranged in offset screwing planes.

Preferably, the axes of the motors are parallel to the axis of the threaded spindle. In one embodiment, the distances between the motor axes and the threaded spindle axis are identical. Alternatively, the distances between the motor axes and the threaded spindle axis are different, wherein the offset between the two distances of the two motor axes is particularly preferably less than 20%. The selection of the distances between the motor axes and the threaded spindle axis is defined depending on the available installation space.

Since the motors can be arranged parallel to one another, preferably on the same side relative to the separating element, the arrangement is advantageously compact and requires no additional installation space.

It is possible that at least one further linear gear comprising a motor, a belt and a drive wheel is located in the linear gear arrangement.

Furthermore, the linear gear arrangement preferably comprises a control unit.

In a further developed embodiment, at least one anti-rotation device (ARD for short) can be arranged on the threaded spindle, which is intended to prevent the free rotation of the spindle nut. The anti-rotation device can be a ball guide, a roller bearing, a sliding member or a sliding sleeve.

Furthermore, the disclosure relates to a motor vehicle having a linear gear arrangement according to the previously described linear gear arrangement with all its embodiments.

### BRIEF DESCRIPTION OF THE DRAWINGS

Further advantages, details and modifications of the linear gear arrangement and motor vehicle having such linear gear arrangement will become apparent from the following description of a preferred embodiment, with reference to the accompanying drawing. In the drawing:

FIG. 1: shows a perspective view of a linear gear arrangement according to the disclosure;

FIG. 2: shows a sectional view of the linear gear arrangement shown in FIG. 1;

FIG. 3: shows a simplified schematic diagram of a section of the linear gear arrangement;

FIG. 4: shows a further perspective view of the linear gear arrangement; and

FIG. 5: shows a perspective view of a road wheel actuator having the linear gear arrangement.

### DETAILED DESCRIPTION

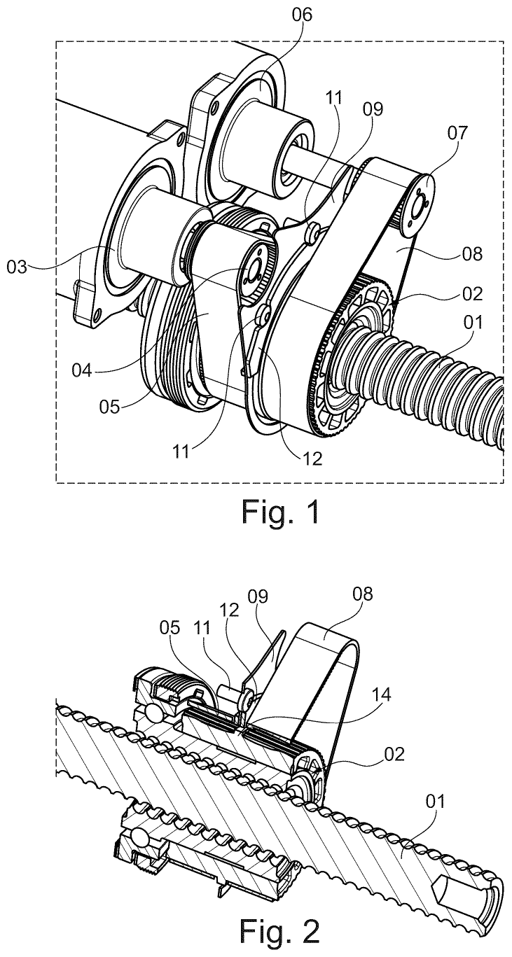

FIG. 1 shows a perspective view of a linear gear arrangement according to the disclosure, which comprises a threaded spindle 01 and a ball screw nut 02 arranged coaxially thereto. The ball screw nut 02 consists of a plurality of components. Furthermore, the linear gear arrangement comprises a first motor 03 having a first belt 05 running around a first drive wheel 04, and a second motor 06 having a second belt 08 running around a second drive wheel 07. The ball screw nut 02 serves as the output wheel for both belts 05, 08, around which the two belts 05, 08 run. The first belt 05 and the second belt 08 are arranged axially adjacent to one another, wherein a separating element 09 is positioned between the two belts 05, 08. The separating element 09 lies axially between the two belts 05, 08 in a radially extending plane and is arranged such that the strand sections of the belts 05, 08 are shielded from one another.

The arrangement comprises redundant components, namely the motors 03; 06, the drive wheels 04; 07, and the belts 05; 08, which serve to ensure the reliability of the linear gear. This reliability is advantageously increased by arranging the separating element 09 between the belts 05, 08, so that if one of the two belts 05; 08 comes off or tears, the failed belt does not impair the function of the belt that is still operational.

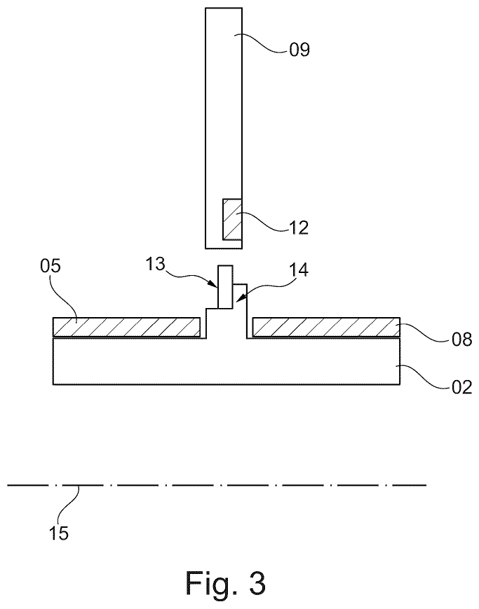

Furthermore, the separating element 09 extends coaxially around the ball screw nut 02. The separating element 09 is fastened to a housing (not shown) with fastening elements 11. On an axially lying side surface, the separating element 09 has a crescent-shaped angle sensor 12, which is designed, for example, in the manner of a printed circuit board. The angle sensor 12 is used to measure the angular position of the ball screw nut 02, wherein it interacts with a target (13, FIG. 3) arranged on the ball screw nut 02.

With the present linear gear arrangement, the absolute angular position of the ball screw nut 02 can be determined using the Vernier principle. For this purpose, the two drive wheels 04, 07 have slightly different diameters, so that there is a transmission ratio, preferably around 3. As a result, the linear gear arrangement advantageously has a high degree of measurement accuracy as well as a high degree of robustness against motor, control and electronic defects, thus ensuring reliability.

FIG. 2 shows a sectional view of the linear gear arrangement shown in FIG. 1, wherein the motors 03; 06 and the drive wheels 04; 07 are not shown. In FIG. 2 it can be seen that the ball screw nut 02 has a circumferential web 14. The web 14 serves as a stop for the two belts 05, 08, but also as a carrier for the target 13.

FIG. 3 shows a simplified schematic diagram of a section of the linear gear arrangement. First, in FIG. 3, an axis of rotation 15 of the threaded spindle 01 is symbolized by a dash-dotted line. Coaxial to the axis of rotation 15 lies the ball screw nut 02 with its radially extending web 14. The web 14 lies axially between the first belt 05 and the second belt 08. The target 13 is arranged on the web 14 and is preferably ring-shaped with wings or cams. The target 13 is arranged in particular on a shoulder formed on the web 14. In the example shown, the target 13 is metallic, so that in interaction with the angle sensor 12, when overlapping, it generates a HF signal from which an angular position of the ball screw nut 02 can be determined. In FIG. 3, the angle sensor 12 is integrated in the separating element 09.

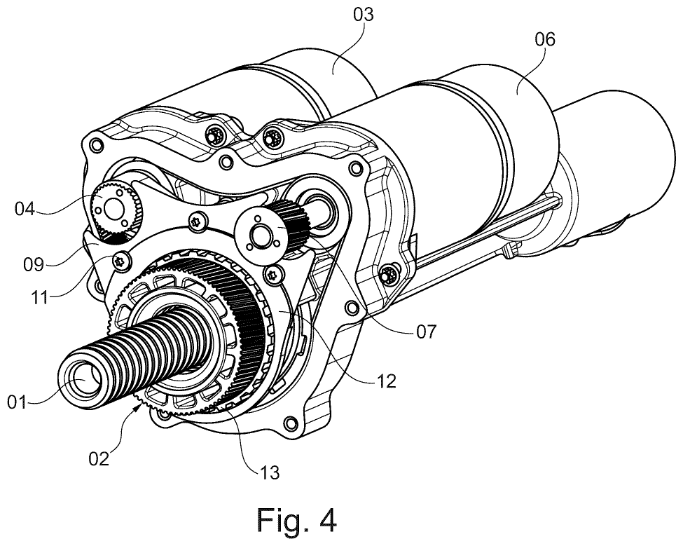

FIG. 4 shows a further perspective view of the linear gear arrangement, wherein the illustration is initially similar to FIG. 1, but the belts 05, 08 are not shown. FIG. 4 clearly shows the crescent-shaped angle sensor 12 arranged on the separating element 09. Furthermore, the target 13 is shown, which is arranged coaxially to the ball screw nut 02 and has radially circumferential cams or elevations.

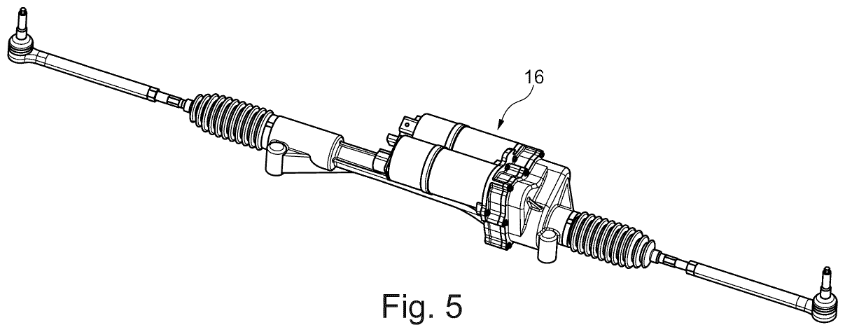

FIG. 5 shows a perspective view of a road wheel actuator having the linear gear arrangement. The road wheel actuator shown here is a module for steering the front axle, which is regularly used in steer-by-wire systems. The linear gear arrangement described above is shown surrounded by a housing 16. In order to ensure correct steering, the position of the steering rod, formed by the threaded spindle 01 described above, and the ball screw nut 02 arranged thereon, must be able to be determined very precisely. This can be achieved with the linear gear arrangement described above.

### LIST OF REFERENCE SIGNS

01 Threaded spindle
02 Ball screw nut/spindle nut
03 First motor
04 First drive wheel
05 First belt
06 Second motor
07 Second drive wheel
08 Second belt
09 Separating element
11 Fastening element
12 Angle sensor
13 Target
14 Web
15 Axis of rotation
16 Housing

1. A linear gear arrangement, comprising:
a threaded spindle;
a spindle nut arranged coaxially to the threaded spindle, which is movable relative to the threaded spindle;
a first motor having a first belt running around a first drive wheel;
a second motor having a second belt running around a second drive wheel;
wherein the first and second belts also wrap around the spindle nut and bear axially adjacent to one another on the spindle nut;
a separating element arranged in a radially extending plane located axially between the first and second belts, the separating element extends radially to shield strand sections of the first and second belts from one another, and the separating element extends coaxially around the spindle nut;
an angle sensor arranged on the separating element; and
a target arranged on the spindle nut, wherein the angle sensor interacts with the target in order to detect an angular position of the spindle nut.

2. The linear gear arrangement according to claim 1, wherein the spindle nut is a ball screw nut.

3. The linear gear arrangement according to claim 1, wherein the linear gear is a ball screw spindle drive, a trapezoidal screw drive, or a planetary roller gearing.

4. The linear gear arrangement according to claim 1, wherein the spindle nut has a web on an outer surface thereof formed as a radially outwardly extending elevation, which is located axially between two bearing surfaces of the belts on the spindle nut.

5. The linear gear arrangement according to claim 4, wherein the radially outwardly extending elevation carries the target.

6. The linear gear arrangement according to claim 1, wherein the linear gear arrangement is a steering gear of a steer-by-wire application.

7. The linear gear arrangement according to claim 1, wherein the target radially has at least one recess.

8. The linear gear arrangement according to claim 1, wherein the target consists of metallic material.

9. The linear gear arrangement according to claim 1, wherein the separating element is a sensor circuit board.

10. The linear gear arrangement according to claim 1, further comprising a plurality of sensors are arranged at or on the separating element.

11. The linear gear arrangement according to claim 1, wherein the first and second drive wheels have different diameters relative to one another.

12. A motor vehicle having a steering gear, wherein the steering gear comprises the linear gear arrangement according to claim 1.

13. A linear gear arrangement, comprising:
a threaded spindle;
a spindle nut arranged coaxially to the threaded spindle, which is movable relative to the threaded spindle;
a first motor having a first belt running around a first drive wheel;
a second motor having a second belt running around a second drive wheel;
wherein the first and second belts also wrap around the spindle nut and bear axially adjacent to one another on the spindle nut;
a separating element arranged axially between the first and second belts, the separating element shields strand sections of the first and second belts from one another, and the separating element extends around the spindle nut;
an angle sensor arranged on the separating element; and
a target arranged on the spindle nut, wherein the angle sensor interacts with the target in order to detect an angular position of the spindle nut.

14. The linear gear arrangement according to claim 13, wherein the spindle nut is a ball screw nut.

15. The linear gear arrangement according to claim 13, wherein the linear gear is a ball screw spindle drive, a trapezoidal screw drive, or a planetary roller gearing.

16. The linear gear arrangement according to claim 13, wherein the spindle nut has a web on an outer surface thereof formed as a radially outwardly extending elevation, which is located axially between two bearing surfaces of the belts on the spindle nut.

17. The linear gear arrangement according to claim 16, wherein the radially outwardly extending elevation carries the target.

18. The linear gear arrangement according to claim 13, wherein the linear gear arrangement is a steering gear of a steer-by-wire application.

19. The linear gear arrangement according to claim 13, wherein the target includes at least one recess.

20. The linear gear arrangement according to claim 13, wherein the separating element is a sensor circuit board.
